(19) United States
(12) Patent Application Publication
(10) Pub. No.: US 2005/0192985 A1
(43) Pub. Date: Sep. 1, 2005

(54) Apparatus and method for classifying files, and computer product

(75) Inventor: Yoshihiro Tsuchiya, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/106,555

(22) Filed: Apr. 15, 2005

Related U.S. Application Data
(63) Continuation of application No. PCT/JP03/04075, filed on Mar. 31, 2003.

(51) Int. Cl. G06F 7/00

(52) U.S. Cl. 707/100

(57) ABSTRACT

A file classifying apparatus for classifying files and directories in a hierarchical tree structure includes a receiving unit, a storing unit, and a writing controlling unit. The receiving unit receives a characteristic value as an index for classifying the files or directories. The storing unit stores management data of the files or the directories for forming a hierarchical tree structure. The writing controlling unit controls and writes the characteristic value received by the receiving unit in the management data.

### BACKGROUND OF THE INVENTION

1) Field of the Invention

This invention relates to classifying files in directories that are arranged in a hierarchical tree structure.

2) Description of the Related Art

A file classifying apparatus that classifies files and directories into a hierarchical tree structure based on management data has been described in Japanese Patent Application Laid-Open Publication No. 2001-134479. Generally, such a file classifying apparatus classifies files and directories by file names and directory names.

For example, the directory “International Patent Classification (IPC)” would have a subdirectory “daily essentials A”. The directory “daily essentials A” would have a subdirectory “Sports A63”. The directory “Sports A63” would have a file “Skate A63C”. In this manner, the files and the directories are arranged in a hierarchical tree structure using the file names or the directory names as indices for classifying the files or the directories.

However, when the factors other than the file names or the directory names change and a new hierarchical structure reflecting such a change is desired, the directory structure cannot be reconstituted unless the file names or directories are changed.

### SUMMARY OF THE INVENTION

It is an object of the present invention to at least solve the problems in the conventional technology.

According to an aspect of the present invention, a file classifying apparatus for classifying files and directories in a hierarchical tree structure includes a receiving unit that receives a characteristic value as an index for classifying the files or the directories; a storing unit that stores management data of the files or the directories for forming a hierarchical tree structure; and a writing controlling unit that provides a control to write the characteristic value received by the receiving unit in the management data.

According to another aspect of the present invention, a method for classifying files and directories in a hierarchical tree structure includes receiving a characteristic value as an index for classifying the files or the directories; storing management data of the files or the directories for forming a hierarchical tree structure; and providing a write control to write the characteristic value received at the receiving in the management data.

According to still another aspect of the present invention, a computer-readable recording medium stores therein a computer program that causes a computer to implement the above method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a file classifying apparatus according to a first embodiment of the present invention;

FIG. 2 is a schematic for explaining a structure of information stored in an inode shown in FIG. 1;

FIG. 3 is a schematic for explaining a writing controlling process performed by the file classifying apparatus shown in FIG. 1;

FIG. 4 is an example of the layout of a screen displayed on an outputting unit shown in FIG. 1;

FIGS. 5A and 5B are schematics for explaining an updating controlling process performed by the file classifying apparatus shown in FIG. 1;

FIG. 6 is a block diagram of a file classifying apparatus according to a second embodiment of the present invention;

FIGS. 7A and 7B are examples of the layout of a screen displayed on an outputting unit shown in FIG. 6;

FIG. 8 is a block diagram of a file classifying apparatus according to a third embodiment of the present invention;

FIG. 9 is a schematic for explaining an updating controlling process performed by the file classifying apparatus shown in FIG. 8;

FIGS. 10A and 10B are schematics for explaining an updating controlling process performed by the file classifying apparatus shown in FIG. 8; and

FIGS. 11A and 11B are examples of the layout of a screen displayed on an outputting unit shown in FIG. 8.

### DETAILED DESCRIPTION

Exemplary embodiments of the present invention are explained with reference to the accompanying drawings.

A file classifying apparatus according to the present invention receives characteristic values as indices for classifying the files and the directories and controls the received characteristic values to be written in the management data of the files or the directories.

Precisely, the file classifying apparatus receives characteristic values defined for each point of view of classifying the files or directories and controls the received characteristic values to be written in the management data in the directory used for the files and the directories. In addition, the file classifying apparatus writes the characteristic values in an inode, of each directory or file that is in a hierarchy lower than the directory or file in which the characteristic values are assigned. The inode is a processing unit that stores a data structure that represents a file or a directory and generally holds file numbers, user names, group names, file sizes, dates and block information and so on. In this manner, the characteristic values are transmitted through the directory structure.

Unlike the conventional technology that uniquely classifies the files and directories by name, according to the present invention, the characteristic values are controlled to be written in the management data for the files and the directories, which enables reconstitution of the directory structure from the point of view different from that of the file name or directory name.

Moreover, according to the present invention, the characteristic values are read and the read characteristic values are controlled to be output. Therefore, the characteristic values can be output at the time the characteristic values are received.

The control is made to output the reconstituted directory structure based on the characteristic values. Therefore, not only the process is performed on the level of the kernel based on the reconstituted directory structure, but also the reconstituted directory structure can be presented to the user.

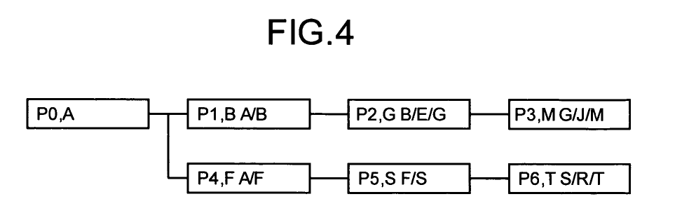

The path name of the directory that is reconstituted based on the characteristic values with referring to the file number of the parent directory from the management data (see FIGS. 4, 7, 11A, and 11B) is output along with the directory structure. Therefore, the correspondence between the directory structure that relates to the file name or the directory name and the directory structure reconstituted based on the characteristic values can be clearly presented to the user.

The directory structure reconstituted based on the characteristic values and the directory structure reconstituted based on the newly written characteristic values conflict partly or entirely, either one of the characteristic values is updated. Therefore, even when new writing occurs that conflict with the directory structure reconstituted based on the characteristic value, the directory structure can be reconstituted without causing logical inconsistency.

The characteristic values are controlled to be updated in response to the variation of the configuration of the directory. Therefore, even when a part of the directory structure is moved or deleted, the directory structure can be reconstituted without causing logical inconsistency.

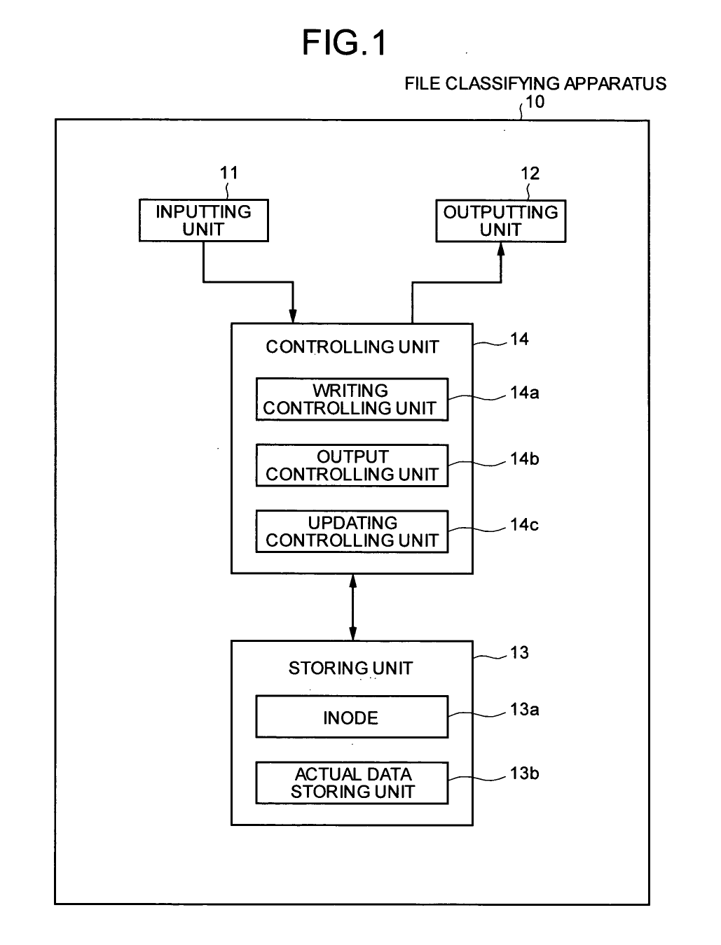

In a first embodiment of the present invention, a file classifying apparatus newly receives characteristic values as indices for classifying files or directories and writes the received characteristic values in the management data for the file or the directory. FIG. 1 is a block diagram of the file classifying apparatus 10 according to the first embodiment. The file classifying apparatus 10 includes an inputting unit 11, an outputting unit 12, a storing unit 13, and a controlling unit 14. The storing unit 13 includes an inode 13a and an actual-data storing unit 13b. The controlling unit 14 includes a writing controlling unit 14a, an output controlling unit 14b, and an updating controlling unit 14c.

The inputting unit 11 is a pointing device, such as a mouse or a track ball, and the user uses the inputting unit 11 to input predetermined instruction. More particularly, the user inputs, using the inputting unit 11, indices for classifying the files or directories, examples of which include a characteristic value that indicates the frequency of backup, a characteristic value that indicates the policy of coding the contents of the file, or a characteristic value that indicates selection of the disk corresponding to the secrecy of the contents of the file. The user also performs, using the inputting unit 11, alteration of the constitution of the directory, for example, movement or deletion of the directory.

The outputting unit 12 is display device such as a Cathode Ray Tube (CRT) display or a Liquid Crystal Display (LCD), for displaying various kinds of information. More particularly, the outputting unit 12 displays the path names between the directories along with the directory structure reconstituted based on the characteristic value written by the writing controlling unit 14a through the output controlling unit 14b (see FIG. 4).

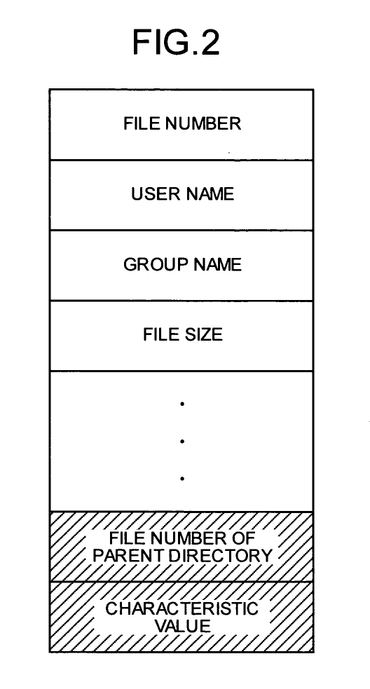

The storing unit 13 stores therein various kinds of computer programs and data. The inode 13a in the storing unit 13 stores therein a data structure that represents a file or a directory and generally holds file numbers, user names, group names, file sizes, dates and block information and so on. In this manner, the characteristic values are transmitted through the directory structure. FIG. 2 is a schematic for explaining the structure of information stored in the inode 13a. The inode 13a includes field in which the file number of the parent or antecedent file is written. When an antecedent directory of a file or directory that is by one rank higher than the file or directory is also called “parent directory”.

The actual-data storing unit 13b stores therein actual data of the file represented by the inode 13a. More particularly, the actual-data storing unit 13b stores various kinds of the actual data, such as image data, document data, and voice data.

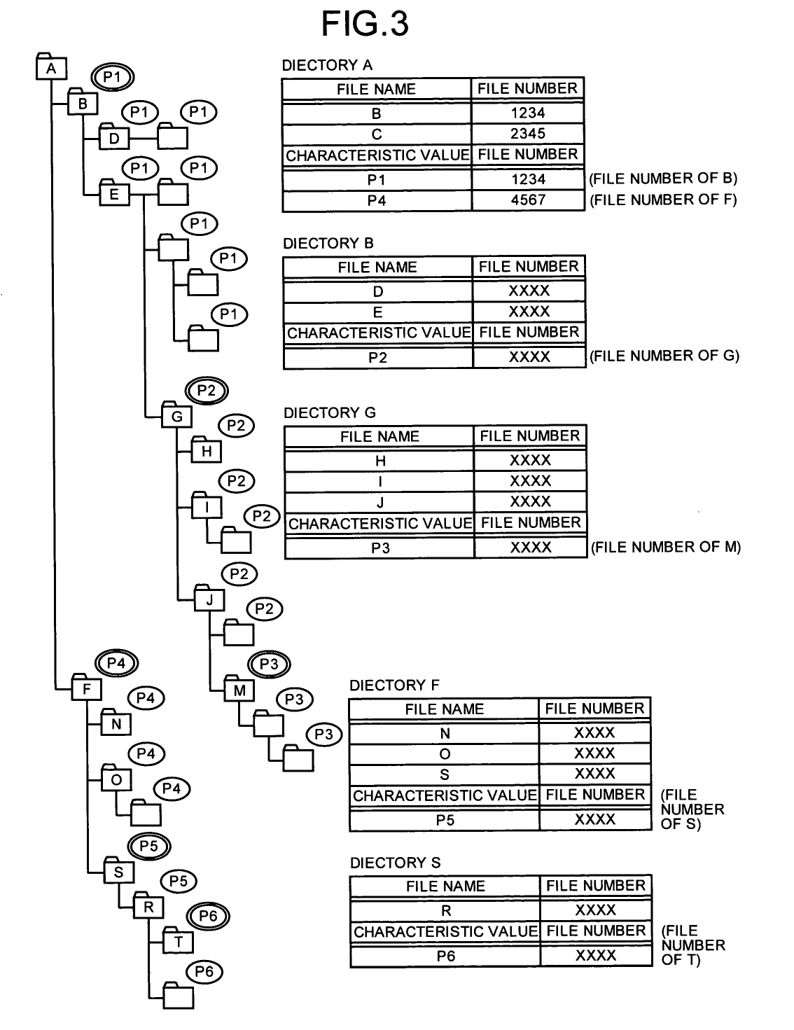

The controlling unit 14 controls the file classifying apparatus 10, and functionally, controls transmission and reception of various kinds of data between the various functional units. The writing controlling unit 14a controls and writes the characteristic value received through the inputting unit 11 in management data. FIG. 3 is a schematic for explaining a writing controlling process performed by the file classifying apparatus 10. It is assumed that a parent directory A has a directory B as a subdirectory and a characteristic value P1 is assigned to the directory B in the directory structure relating to the file name or the directory name. In this case, the characteristic value P1 and the file number of the directory B are written in the management data in the parent directory of the directory B, i.e., the directory A, and the characteristic value P1 is written in the inode 13a of the directory B. Moreover, the characteristic value is transmitted by writing the characteristic value P1 in the inode 13a of each of directories D and E, which have entries in a lower rank than the directory B in which the characteristic value is assigned. In a similar manner, characteristic values P2, P3, P4, P5, and P6 are assigned to directories G, M, F, S, and T.

The output controlling unit 14b prepares a display screen for outputting the results of the process performed by the writing controlling unit 14a. The display screen is displayed on the outputting unit 12. More particularly, the output controlling unit 14b controls in such a manner that when the writing controlling units writes a characteristic value and the characteristic value is received, the output controlling unit 14b reads a characteristic value and outputs the characteristic value.

Moreover, the output controlling unit 14b controls to output the path name between the directories along with the directory structure reconstituted based on the characteristic value written by the writing controlling unit 14a. The output control can be performed by referring back one by one the file number of the parent directory stored in the inode 13a (see FIG. 4). This can clearly indicate a correspondence between the directory structure relating to the file name or the directory name and the directory structure reconstituted based on the characteristic value.

According to the first embodiment, the file classifying apparatus 10 receive characteristic values as indices for classifying the files or the directories, and controls and write the received characteristic values in the management data of the files or the directories. Therefore, the directory structure can be reconstituted based on indicies that are different from the file name or the directory name.

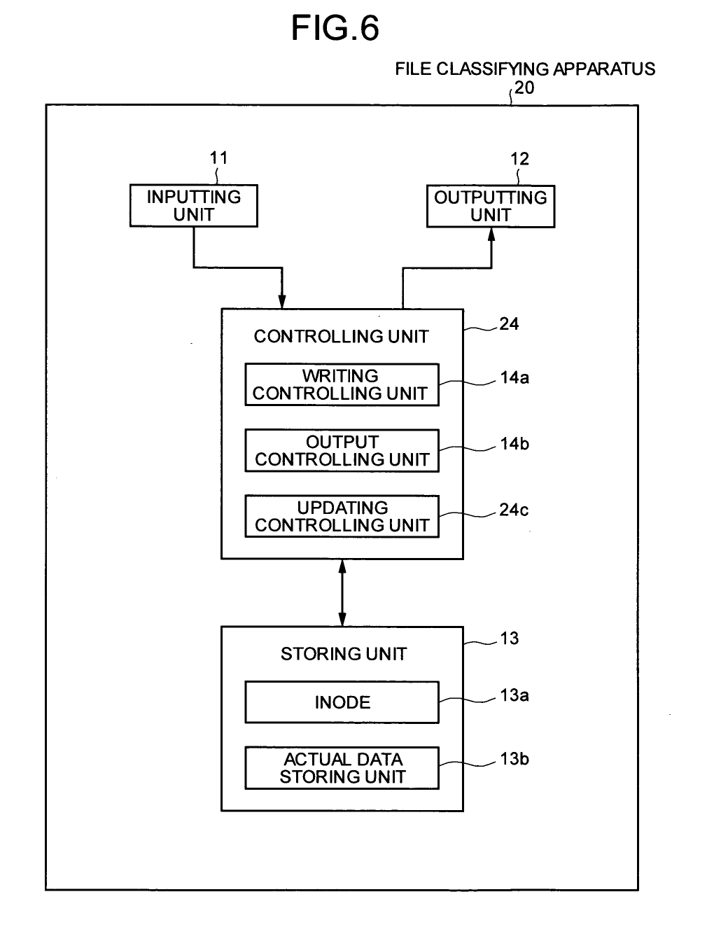

A file classifying apparatus according to a second embodiment of the present invention is explained next. This file classifying apparatus updates either one of the characteristic values when the directory structure that is reconstituted based on the characteristic values conflicts with the part or all of the directory structure that is reconstituted based on the newly written characteristic values. FIG. 6 is a block diagram of a file classifying apparatus 20 according to the second embodiment. The file classifying apparatus 20 includes the inputting unit 11, the outputting unit 12, a controlling unit 24, and the storing unit 13. The inputting unit 11, the outputting unit 12, and the storing unit 13 are the same as those shown in FIG. 1 therefore their explanation is omitted herefrom. The controlling unit 24 includes the writing controlling unit 14a, the output controlling unit 14b, and an updating controlling unit 24c. The writing controlling unit 14a and the output controlling unit 14b are the same as those shown in FIG. 1 therefore their explanation is omitted herefrom.

The updating controlling unit 24c updates either one of the characteristic values when the directory structure reconstituted based on the characteristic values and the directory structure reconstituted based on the newly written characteristic values conflict with each other partly or entirely.

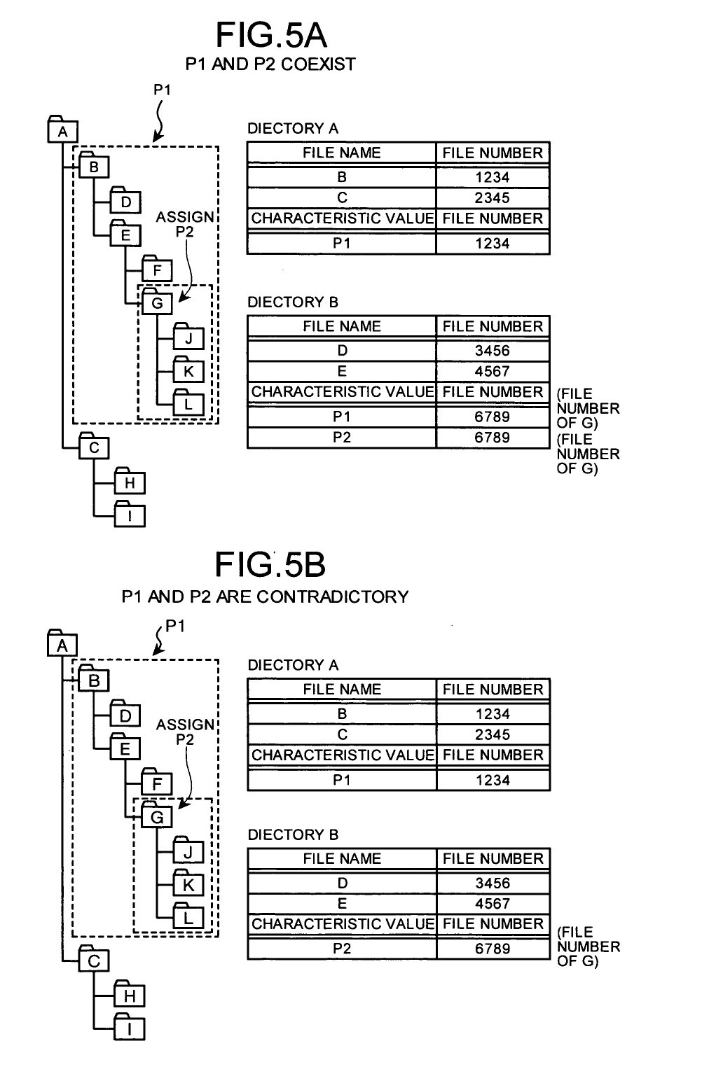

FIGS. 5A and 5B are schematics for explaining an updating controlling process according to the present invention. For example, when it is attempted to assign the characteristic value P2 to the directory G in the directory structure shown in FIG. 5A and 5B, there are two situations. In one situation, the characteristic values P1 and P2 can coexist (FIG. 5A), and in the other situation, the characteristic values P1 and P2 are contradictory and cannot coexist (FIG. 5B). When the characteristic values P1 and P2 can coexist (FIG. 5A), the characteristic values P1 and P2, and the file number of the directory G are written in the management data in the directory B, and the characteristic values P1 and P2 are also written in the inode 13a in the directory G. The directory B is higher in the hierarchy or antecedent to the directory G in the directory structure reconstituted based on the characteristic value. The directory B can be identified by tracing back antecedent directories based on information on the files or directories written in the inodes 13a. For example, when antecedent directories are traced back starting from the directory E that is a parent directory to the directory G and whose file number is written in the inode 13a of the directory G ,and the directory A is reached, the directory B can be identified. Moreover, the characteristic values P1 and P2 are written in the inodes 13a of directories J, K, and L lower in the hierarchy than or descendent to the directory G to transmit the characteristic values (see FIG. 5A).

When the characteristic values P1 and P2 are contradictory and cannot coexist (see FIG. 5B), the characteristic value P1 is deleted from the inode 13a of each directory that is lower in hierarchy than the directory G, and the characteristic value and the file number of the directory G are written in the management data of the directory B; and the characteristic value P2 is written in the inode 13a of the directory G. Moreover, the characteristic value P2 is written in the inodes 13a of the directories J, K, and L to transmit the characteristic value P2 (see FIG. 5B).

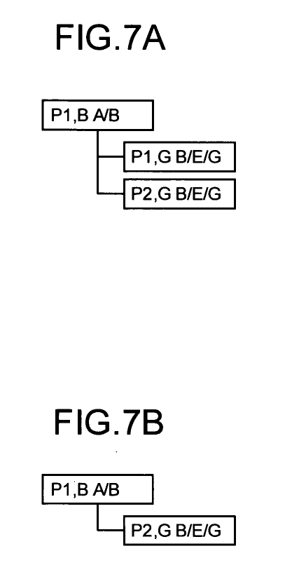

The output controlling unit 14b controls the outputting unit 12 to display the relationship between the directory structure reconstituted based on the characteristic value that is updated by the updating controlling unit 24c and the directory structure based on the file name or the directory name. FIG. 7A shows the relationship when the characteristic values P1 and P2 can coexist while FIG. 7B shows the relationship when the characteristic values P1 and P2 are contradictory and cannot coexist.

The file classifying apparatus 20 can reconstitute the directory structure without contradictions even when new writing is made in contradiction to the directory structure reconstituted based on the previous characteristic values.

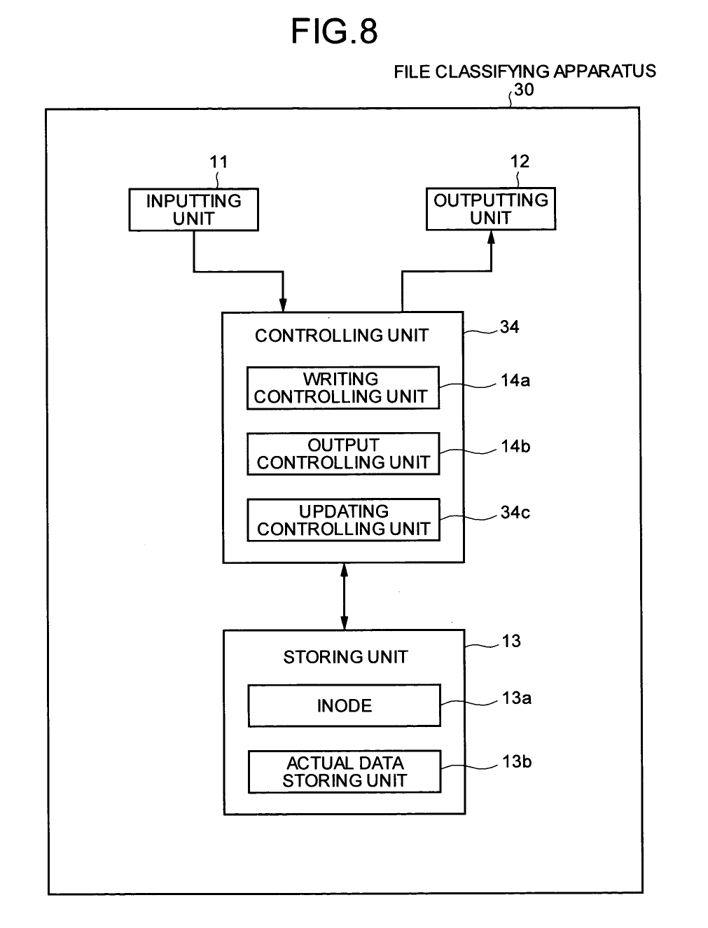

A file classifying apparatus according to a third embodiment of the present invention is explained next. FIG. 8 is a block diagram of a file classifying apparatus 30 according to the third embodiment. The file classifying apparatus 30 includes the inputting unit 11, the outputting unit 12, a controlling unit 34, and the storing unit 13. The inputting unit 11, the outputting unit 12, and the storing unit 13 are the same as those shown in FIG. 1. The controlling unit 34 includes the writing controlling unit 14a, the output controlling unit 14b, and an updating controlling unit 34c. The writing controlling unit 14a and the output controlling unit 14b are the same as those shown in FIG. 1. Only the differences from the first and the second embodiments are explained.

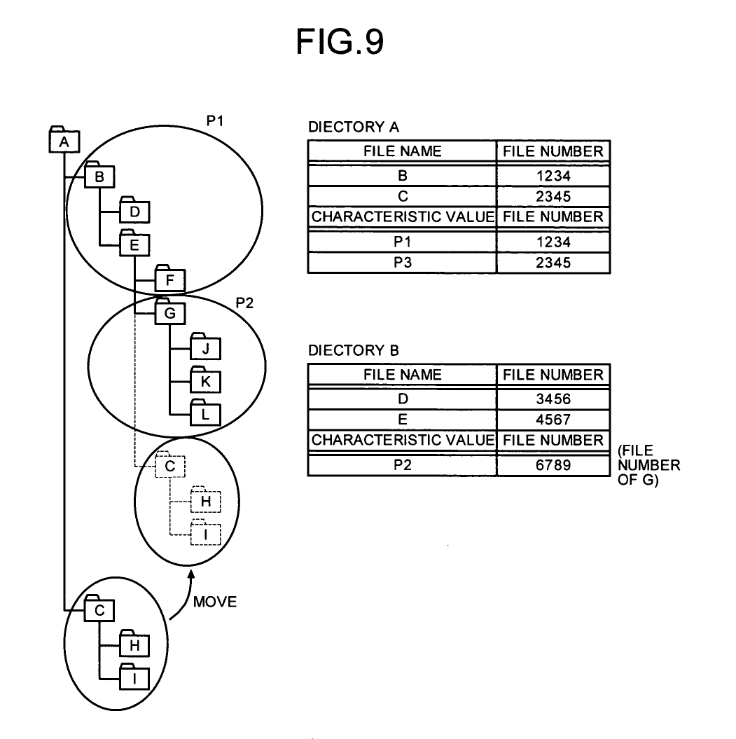

The file classifying apparatus 30 controls the directory structure in such a manner that the characteristic value is updated corresponding to a change in the directory structure. FIG. 9 is a schematic for explaining an updating controlling process according to the present invention. The updating controlling unit 34c controls and updates the characteristic value according to a change in the directory structure. More particularly, when a directory moves to become a subdirectory of another directory, the updating controlling unit 34c updates the characteristic value according to this change in the directory. For example, in the directory structure shown in FIG. 9, when it is attempted to move the directory C to become a subdirectory of the directory E, the updating of the characteristic value is performed in different manners depending on situations.

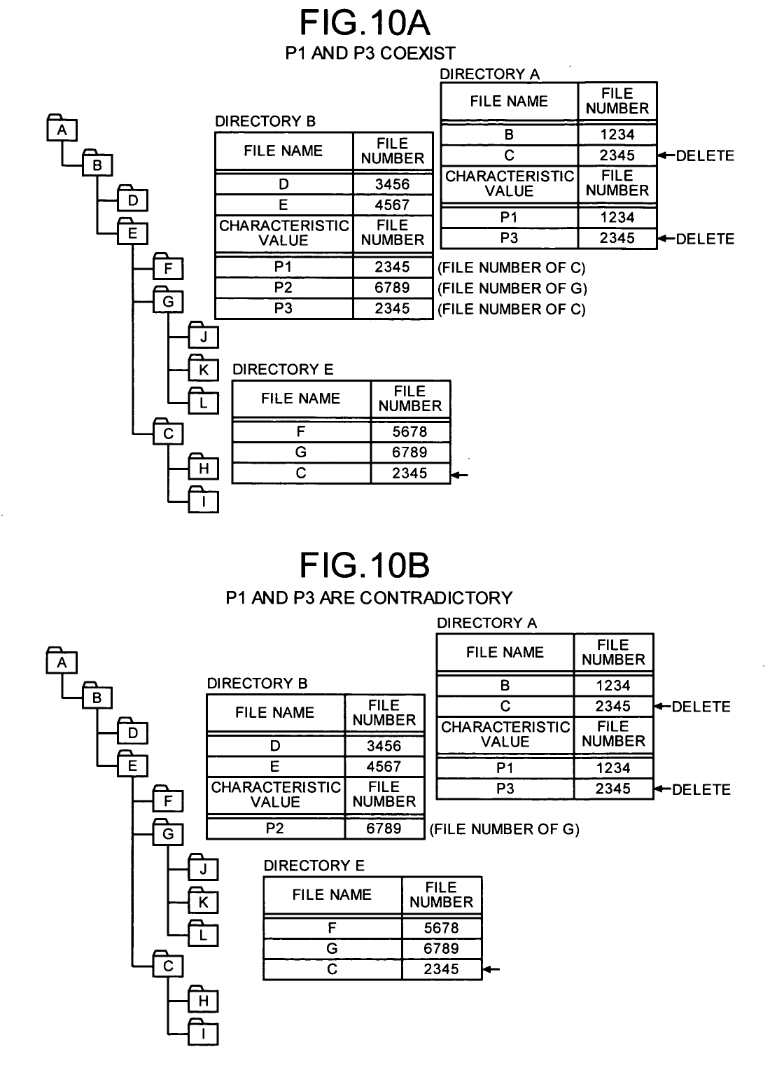

FIGS. 10A and 10B are schematics for explaining an updating controlling process according to the present invention. For example, suppose the directory C is moved to become a subdirectory of the directory E, there are two situations. In one situation, the characteristic values P1 and P3 can coexist, and in the other situation, the characteristic values P1 and P3 are contradictory and cannot coexist. When the characteristic values P1 and P3 can coexist, the data about the directory C are removed from the directory A, and then the file name and file number of the directory C are written in the directory E, that is, the parent directory of the directory C. Subsequently, the characteristic values P1 and P3 and the file number of the directory C, the moving directory, are written in the management data of the directory B, and at the same time the characteristic values P1 and P3 are written in the inode 13a of the directory C. The characteristic values P1 and P3 are written in the inodes 13a of the directories H and I that are lower in hierarchy than the directory C of which the characteristic value is updated to transmit the characteristic values (see FIG. 10A).

When the characteristic values are contradictory and cannot coexist, the data about the directory C are removed from the directory A, and then the file name and file number of the directory C are written in the directory E. Subsequently, the characteristic value P1 and the file number of the directory C, the moving directory, are written in the management data of the directory B, and at the same time the characteristic value P1 is written in the inode 13a of the directory C. The characteristic value P1 is written in the inodes 13a of the directories H and I that are lower in hierarchy than the directory C of which the characteristic value is updated to transmit the characteristic values (see FIG. 10B).

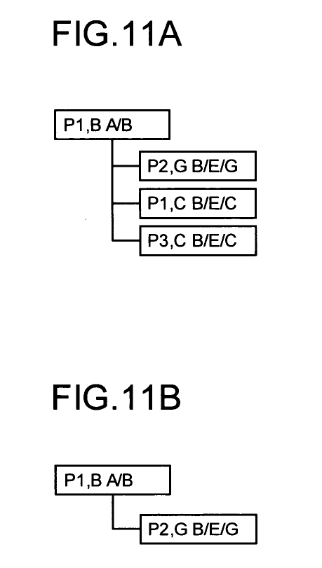

The output controlling unit 14b controls the outputting unit 12 to display the relationship between the directory structure reconstituted based on the characteristic value that is updated by the updating controlling unit 34c and the directory structure based on the file name or the directory name. FIG. 11A shows the relationship when the characteristic values P1 and P3 can coexist while FIG. 11B shows the relationship when the characteristic values P1 and P3 are contradictory.

The file classifying apparatus 30 controls and updates the characteristic value corresponding to the change in the directory structure. Accordingly, when a part of the directory structure is moved or deleted, the directory structure can be reconstituted without contradictions.

The present invention can be practiced in various embodiments other than the first to the third embodiments described above.

Although the present invention has been explained about embodiments in which the relationship between the directory structure reconstituted based on the characteristic value and the directory structure relating to the file name and the directory name is output, the present invention is not limited to such embodiments. For example, directory structures relating to specified characteristic values only can be output similarly.

All or a part of the processes that have been explained as being performed automatically, for example, writing controlling process or updating controlling process, in the above-mentioned embodiments may be performed manually, or all or a part of the processes that have been explained as being performed manually may be performed automatically by known methods. The process procedures, control procedures, specific names, information containing various data and parameters, for example, characteristic values, may be changed arbitrarily unless otherwise indicated specifically.

The file management methods (“writing controlling process” and “updating controlling process”) explained in the above-mentioned embodiments can be realized by making the computer execute a computer program provided beforehand. The computer program can be distributed through a network such as the Internet. The computer program can be stored, for example, in a computer-readable recording medium such as a hard disk, a flexible disk (FD), a compact disk read only memory (CD-ROM), a magnetooptic (MO) disk, or a digital versatile disk (DVD). The computer can read the computer program from the computer-readable recording medium having recorded therein the program and execute the program.

According to the present invention, the characteristic values as indices for classifying the files or directories are controlled to be received and written in the management data in the directory. Therefore, the directory structure can be reconstituted based on different indices than the file names or the directory names. When the indices are selected appropriately, the reconstituted directory structure suitable for various purposes can be obtained.

According to the present invention, the characteristic value is read and the read characteristic value is controlled to be output. Therefore, the characteristic value can be recognized when the characteristic value is received. This makes reconstitution of the directory structure easy.

According to the present invention, the directory structure reconstituted based on the characteristic value is output. Therefore, the user can see the reconstituted directory structure while the processing on the level of the kernel based on the reconstituted directory structure is in process. This is convenient to the user since the user can check errors, if any, easily.

According to the present invention, the path name between the directories reconstituted based on the characteristic value referring to the file numbers of the antecedent directories in the management data is output together with the reconstituted directory structure. Therefore, the user can clearly understand the relationship between the directory structure relating to the file name or the directory name and the directory structure reconstituted by the characteristic value.

According to the present invention, when the directory structure reconstituted based on the characteristic values and the directory structure reconstituted based on the newly written characteristic values conflict partly or entirely, either one of the characteristic values is updated. Therefore, the directory structure can be reconstituted without causing logical inconsistency even when new writing that conflicts partly or entirely with the directory structure that is reconstituted based on the characteristic value.

According to the present invention, the characteristic values are controlled to be updated in response to the variation of the configuration of the directory. Therefore, the directory structure can be reconstituted without causing logical inconsistency even when a part of the directory structure is moved or deleted.

According to the present invention, the characteristic value that indicates the frequency of backup, the characteristic value that indicates the policy of coding the contents of the file, or the characteristic value that indicates selection of the disk corresponding to the secrecy of the contents of the file is received as an index for classifying the files or directories, and the received characteristic value is written in the management data of the file or directory. Therefore, the directory structure can be reconstituted from various points of view.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A file classifying apparatus for classifying files and directories in a hierarchical tree structure, comprising:
a receiving unit that receives a characteristic value as an index for classifying the files or the directories;
a storing unit that stores management data of the files or the directories for forming a hierarchical tree structure; and
a writing controlling unit that provides a control to write the characteristic value received by the receiving unit in the management data.

2. The file classifying apparatus according to claim 1, further comprising:
an output controlling unit that provides a control to read the characteristic value written by the writing controlling unit from the storing unit and a control to output the read characteristic value.

3. The file classifying apparatus according to claim 2, wherein the output controlling unit provides a control to classify the files or the directories based on the read characteristic value to form a reconstituted directory structure.

4. The file classifying apparatus according to claim 3, wherein
the management data include a file number of a directory antecedent to the file or the directory,
the reconstituted directory structure has a name of path between the reconstituted directories, and
the output controlling unit provides a control to output the name of the path between the reconstituted directories together with the directory structure.

5. The file classifying apparatus according to claim 3, further comprising:
an updating controlling unit that provides a control to update one of the already written characteristic value and a characteristic value newly written when the reconstituted directory structure and a reconstituted directory structure that is reconstituted based on the characteristic value newly conflict partly or entirely.

6. The file classifying apparatus according to claim 5, wherein the updating controlling unit provides a control to update the characteristic value corresponding to a change in the directory structure.

7. The file classifying apparatus according to claim 1, wherein
the receiving unit receives one member selected from the group consisting of a characteristic value that indicates a frequency of backup, a characteristic value that indicates a policy of coding the content of the file, and a characteristic value that indicates selection of a disk corresponding to a degree of secrecy of the content of the file as the index for classifying the files or the directories, and
the writing controlling unit provides a control to write the received characteristic value in the management data of the file or the directory.

8. A method for classifying files and directories in a hierarchical tree structure, comprising:
receiving a characteristic value as an index for classifying the files or the directories;
storing management data of the files or the directories for forming a hierarchical tree structure; and
providing a write control to write the characteristic value received at the receiving in the management data.

9. The method according to claim 8, further comprising:
providing a read control to read the characteristic value written at the providing the write control; and
providing an output control to output the read characteristic value.

10. The method according to claim 9, wherein the output control includes classifying the files or the directories based on the read characteristic value to form a reconstituted directory structure.

11. The method according to claim 10, wherein
the management data include a file number of a directory antecedent to the file or the directory,
the reconstituted directory structure has a name of path between the reconstituted directories, and
the output control includes controlling to output the name of the path between the reconstituted directories together with the directory structure.

12. The method according to claim 10, further comprising:
providing an updating control of controlling to update one of the already written characteristic value and a characteristic value newly written when the reconstituted directory structure and a reconstituted directory structure that is reconstituted based on the characteristic value newly conflict partly or entirely.

13. The method according to claim 12, wherein the updating control includes controlling to update the characteristic value corresponding to a change in the directory structure.

14. The method according to claim 8, wherein
the receiving includes receiving one member selected from the group consisting of a characteristic value that indicates a frequency of backup, a characteristic value that indicates a policy of coding the content of the file, and a characteristic value that indicates selection of a disk corresponding to a degree of secrecy of the content of the file as the index for classifying the files or the directories, and
the writing control includes controlling to write the received characteristic value in the management data of the file or the directory.

15. A computer-readable recording medium that stores therein a computer program that causes a computer to implement a method for classifying files and directories in a hierarchical tree structure, the computer program causing the computer to execute:
receiving a characteristic value as an index for classifying the files or the directories;
storing management data of the files or the directories for forming a hierarchical tree structure; and
providing a write control to write the characteristic value received at the receiving in the management data.
